(19) United States
(12) Patent Application Publication
(10) Pub. No.: US 2025/0124358 A1
(43) Pub. Date: Apr. 17, 2025

(54) METHOD AND APPARATUS FOR ANALYZING UNSTRUCTURED DATA TO CONDITION SIGNALS FOR FACILITATING PROVISION OF MERCHANT LOSS PREVENTION

(71) Applicant: Affirm, Inc., San Francisco, CA (US)

(72) Inventors: Hong LIN, San Francisco, CA (US); Yuan YAO, Sunnyvale, CA (US)

(21) Appl. No.: 18/891,122

(22) Filed: Sep. 20, 2024

Related U.S. Application Data
(63) Continuation-in-part of application No. 18/487,563, filed on Oct. 16, 2023.

(51) Int. Cl. G06Q 10/02; G06F 16/951

(52) U.S. Cl. CPC G06Q 10/02; G06F 16/951

(57) ABSTRACT

A method of extracting and conditioning content for use in a hierarchically structured merchant risk monitoring environment may include receiving an indication of a merchant under consideration, identifying one or more web pages likely to have information associated with travel exposure for the merchant under consideration based on the indication, conducting data scraping on the identified one or more web pages to attempt to obtain scraped travel exposure data, responsive to obtaining the scraped travel exposure data, employing a machine learning module to determine a travel risk exposure estimate based on the scraped travel exposure data, and responsive to not obtaining the scraped travel exposure data, determining the risk exposure estimate based on a predefined travel risk estimate associated with an industry classification of the merchant under consideration.

### TECHNICAL FIELD

Example embodiments generally relate to financial industry technologies and, in particular, relate to apparatuses, systems, and methods for extracting data from unformatted sources using artificial intelligence and machine learning to provide signals for determining merchant credit risk.

### BACKGROUND

The financial industry is comprised of many thousands of customers, vendors, lenders, borrowers, and other role players that all interact in various ways to enable customers to ultimately have access to goods and services provided by vendors. Credit and debit transactions have long been a way that individuals have managed point of sale transactions to ensure seamless transfer of funds from customers, or on their behalf, to vendors for relatively routine or small transactions. Meanwhile, obtaining a loan from a bank has long been the most common way of obtaining financing for non-routine or larger transactions.

In recent times, merchant websites have integrated a number of different payment options that the user may choose from when arriving at checkout. The user may then select one of the payment options (e.g., credit, debit, mobile wallet, loan, etc.) and attempt to pay for the final amount using the selected method. With many of these payment methods, however, the user could still be declined/denied, and the transaction may not be able to be completed.

It would be preferable to avoid aggravating users by serving them a denial or decline notice after very nearly reaching the finish line, and doing so would certainly improve their shopping experience. It would also help merchants by ensuring that transactions can be completed with satisfied customers who may build brand loyalty to the merchant as a result. However, the risk of non-payment by the customer on credit extended to them must always be balanced against these interests. Meanwhile, although customers are often the focus of risk considerations, merchant risks are also important to consider. In this regard, for example, some merchants who accept card payments or loan-financed transactions have a risk of chargebacks, fraud, business closure, or other situations that may ultimately cause exposure for lenders or facilitators of credit/debit transactions. Although balancing these risks is often a technical issue that is solved with the application of various models or algorithms for managing risk, such models and algorithms tend to further require a balance between processing speed (without which the decisions that result therefrom are less useful) and data inclusion (which if expansive will negatively impact processing speed and accuracy). This technical problem is exacerbated by the fact that for some payment options, such as provision of a loan or extension of credit, the lender is typically only informed of the details of the transaction at the very end of the process, i.e., at checkout, and time is of the essence. In short, the need for speed, and the need for data inclusion to improve accuracy are two factors that directly compete against each other and are typically extremely difficult to balance without deciding a clear winner (and therefore also a loser) on one side or the other of the balance equation.

Example embodiments are aimed at creating a technical platform that uses intelligent technical means by which to not only reduce merchant risk exposure a lender or payments provider may be exposed to during the normal course of lending, but also do so using high powered tools that improve the efficiency of resources used while increasing the speed of operations, and doing so without sacrificing the inclusiveness and volume of information considered.

### BRIEF SUMMARY OF SOME EXAMPLES

Accordingly, some example embodiments may enable the provision of technical means by which to give a facilitator of loans the ability to integrate into an ecosystem for supporting commerce between merchants and customers, and employ technical tools that are able to consume and evaluate massive amounts of information efficiently for the management of merchant risk.

In an example embodiment, a method of extracting and conditioning content for use in a hierarchically structured merchant risk monitoring environment may be provided. The method may include receiving an indication of a merchant under consideration, identifying one or more web pages likely to have information associated with travel exposure for the merchant under consideration based on the indication, conducting data scraping on the identified one or more web pages to attempt to obtain scraped travel exposure data, responsive to obtaining the scraped travel exposure data, employing a machine learning module to determine a travel risk exposure estimate based on the scraped travel exposure data, and responsive to not obtaining the scraped travel exposure data, determining the risk exposure estimate based on a predefined travel risk estimate associated with an industry classification of the merchant under consideration.

In another example embodiment, an apparatus for extracting and conditioning content for use in a hierarchically structured merchant risk monitoring environment may be provided. The apparatus may include processing circuitry configured for receiving an indication of a merchant under consideration, identifying one or more web pages likely to have information associated with travel exposure for the merchant under consideration based on the indication, conducting data scraping on the identified one or more web pages to attempt to obtain scraped travel exposure data, responsive to obtaining the scraped travel exposure data, employing a machine learning module to determine a travel risk exposure estimate based on the scraped travel exposure data, and responsive to not obtaining the scraped travel exposure data, determining the risk exposure estimate based on a predefined travel risk estimate associated with an industry classification of the merchant under consideration.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a functional block diagram of a system for providing a selective financing and payment platform according to an example embodiment;

FIG. 2 illustrates a functional block diagram of an apparatus for defining a facilitation agent according to an example embodiment;

FIG. 3 illustrates a block diagram of a risk rating module in accordance with an example embodiment;

FIG. 4 illustrates a dashboard for merchant risk monitoring in accordance with an example embodiment;

FIG. 5 illustrates a block diagram of a travel risk rating module in accordance with an example embodiment;

FIG. 6 illustrates a structured output table for providing outputs from a large language model stage in accordance with an example embodiment;

FIG. 7 illustrates a heat map in which a selected volume drop cutoff curve may be determined in accordance with an example embodiment; and

FIG. 8 is a block diagram of a method for extracting and conditioning content for use in a hierarchically structured merchant risk monitoring environment in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other. Additionally, when the term “data” is used, it should be appreciated that the data may in some cases include simply data or a particular type of data generated based on operation of algorithms and computational services, or, in some cases, the data may actually provide computations, results, algorithms and/or the like that are provided as services.

As used in herein, the term “module” is intended to include a computer-related entity, such as but not limited to hardware, firmware, or a combination of hardware and software (i.e., hardware being configured in a particular way by software being executed thereon). For example, a module may be, but is not limited to being, a process running on a processor, a processor (or processors), an object, an executable, a thread of execution, and/or a computer. By way of example, both an application running on a computing device and/or the computing device can be a module. One or more modules can reside within a process and/or thread of execution and a module may be localized on one computer and/or distributed between two or more computers. In addition, these components can execute from various computer readable media having various data structures stored thereon. The modules may communicate by way of local and/or remote processes such as in accordance with a signal having one or more data packets, such as data from one module interacting with another module in a local system, distributed system, and/or across a network such as the Internet with other systems by way of the signal. Each respective module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Some example embodiments described herein provide for a data processing platform that can be instantiated at an apparatus comprising configurable processing circuitry. The processing circuitry may be configured to execute various processing functions on financial data using the techniques described herein. The data processing platform may, for example, be configured to provide an information exchange via which multiple independent or even proprietary platforms may be connected to each other. As such, the data processing platform may be embodied as a selective financing and payment platform (i.e., SFP platform) that connects customers and merchants (or vendors) to banks, payment services, and a transaction facilitator within the financial industry. By enabling data between the players on or members of the platform to be shared, and by further providing customers with tools for using the platform to manage individual transactions before, during and also sometimes after the transactions occur, customers and merchants may have increased flexibility for managing their funds in a way that prevents over-extension, while still maximizing their access to the goods and services they desire or need at any given time. Moreover, the platform may be employed under the management of the facilitator to control the usage of data on mutually agreeable terms for all participants who access the platform. Accordingly, a commercial framework can be provided by a technical platform designed to connect customers and merchants with access to financial support to effect transactions in real time with added flexibility to determine terms upon which each transaction will be executed with participating merchants.

The technical platform described herein, however, further streamlines integration of merchants who wish to participate as a member of the ecosystem created by example embodiments by providing customers on a website or application of the facilitator with tools that enable the customers to proactively view the financing possibilities that can be accessed to their advantage for each of a plurality of merchants. In particular, customers may be enabled to see merchant-specific advertisements, offers, or the like that may include financing options (e.g., loans, credit extensions, etc.) for which the customer may seek approval to use when the customer reaches the checkout page of the corresponding merchant(s). When the merchants are brought into the ecosystem, however, merchant risk can also be evaluated using the tools described herein and a monitoring framework may further be provided to enable the risk rating assigned to the merchants to be continuously updated in order to predict or prevent loss and/or fraud. The integrity of the entire system to reward positive actors and inhibit negative actors is enhanced by minimizing the risk of any parties behaving in a way that would negatively impact another party.

For example, instead of merely having a passive platform that enables merchants who desire to become members of the ecosystem to become members and take payments within the system, example embodiments will provide a technical means by which to give the facilitator of transactions the ability to continuously and accurately evaluate merchant risk using high powered technical tools. The creation of a technical platform that proactively evaluates merchant risk on a merchant by merchant basis and, in some cases, specific to the products offered (or industry verticals), may improve the financial performance of the facilitator or lender, while also improving the customer shopping experience and driving loyalty to both the merchant (or its brands) and to the facilitator. This paradigm may provide one platform, managed by the facilitator, for the interaction of multiple parties to enable usage of the platform to provide a flexible and yet cohesive experience for customers that maximizes responsible access to financial freedom and satisfaction without unduly extending the risk to the facilitator.

Within that generally context, it should be noted that when evaluating risk associated with merchants specifically, there can be a number of different aspects or drivers of that risk that should be considered. Each of these may be considered to be a respective different type of risk having its own respective risk exposure that can be evaluated. In this context, “exposure” may be defined as the monetary value (e.g., dollar value) at risk that a merchant is not able to fulfill due to various reasons (e.g., fraud, bankruptcy, shutdown, etc.). Exposure may be broken down into different parts or types including, for example, dispute exposure, refund exposure, and travel exposure (or delayed delivery days (DDD) exposure). Of these, historically travel exposure has typically been extremely difficult to estimate for facilitators. In this regard, travel exposure itself has multiple component exposures, and each of those component exposures is both potentially subject to being associated with very different indicators, and those very different indicators are also often buried within unstructured data and information sources that (until now) have been virtually impossible to evaluate and identify. The impossibility of identification has to do with the potential unstructured nature of the data and information at a first level, but at a second level is further exacerbated by the utterly massive amounts of information (literally terabytes of information in some cases) in which the indicators are buried.

With one significant type of exposure virtually incapable of accurate estimation, crude techniques that amount to not much more than guesses based on industry wide averages have been used to date. However, while that estimation is better than nothing, there is an opportunity to increase both transaction volume and profitability if more accurate and more individually applicable risk rating can be achieved. In this regard, instead of treating all merchants in a particular segment the same based on industry averages for that segment, a facilitator that can accurately rate individual merchants within the segment both positively and negatively can treat each of the individual merchants accordingly and thereby cause the performance of the segment to beat industry averages in many cases. So the question clearly becomes how does one more accurately estimate exposure risk, particularly for travel exposure (e.g., DDD exposure) within a universe of massive amounts of potentially unstructured data, especially when time is of the essence and speed and accuracy often play against each other?

Conventional computing techniques, hardware and software applications cannot begin to address this problem. The number of computations, and the requirement for making timely judgements are simply beyond the capacity of general purpose computing assets. What is instead needed is the employment of powerful tools that make possible that which is otherwise not possible for the diverse and massive data sets that must be studied in the timeframes of interest. Example embodiments therefore answer the question outlined above by employing generative artificial intelligence (AI) and machine learning (ML) tools in the SFP platform to employ a paradigm shift with respect to the ability of a facilitator to estimate merchant risk.

Example embodiments not only provide the SFP platform, but also provide various enabling technologies that may facilitate operation of the SFP platform itself or of modules that may interact with the SFP platform for processing transactions amongst parties that engage with, or are members, of the ecosystem created by the SFP platform. Example embodiments therefore provide the SFP platform, supporting structures and technologies for its use, and also for processing transactions between members (e.g., lenders, customers and merchants). Moreover, as noted above, the SFP platform further takes an active role in identifying a level at which various merchants are eligible to participate in the SFP platform, and engages with such merchants in order to facilitate their easy access to participating in the ecosystem and to the customers who are also members of the ecosystem. In other words, example embodiments may also provide for enhancement of functionalities associated with the environment that is created by the SFP platform, particularly in relation to the enabling of merchants that become members of or participants in the ecosystem of the SFP platform to engage with customers via sales, offers or other marketing efforts (all referred to herein generally as examples of marketing events) for which tools to facilitate evaluating merchant risk relative to enabling the merchants with respect to generation of content associated with the sales, offers or other marketing efforts are provided via the SFP platform. The SFP platform may therefore provide a technical mechanism by which to enhance commerce in a responsible way that is both empathetic and empowering to customers and merchants, but also manages risk to the facilitator using efficient resource management.

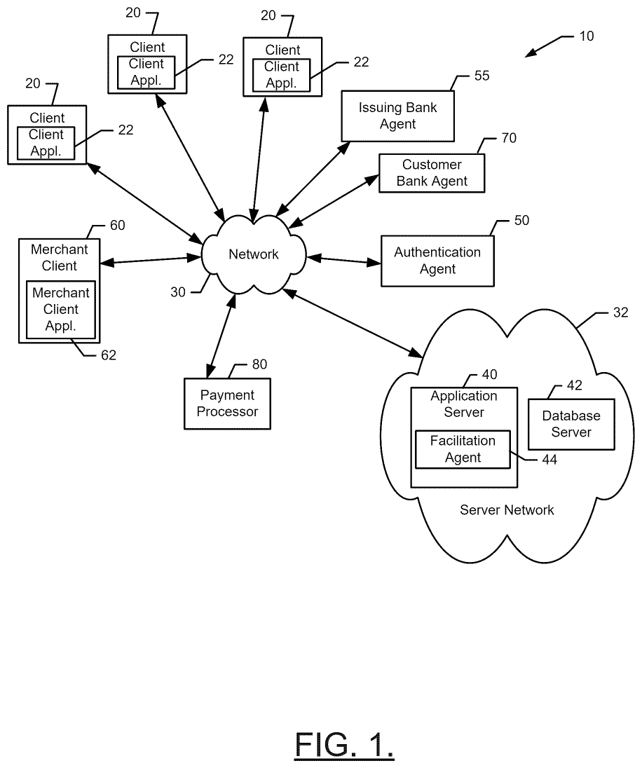

An example embodiment will now be described in reference to FIG. 1, which illustrates an example system in which an embodiment of the present invention may be employed. As shown in FIG. 1, a system comprising an SFP platform 10 according to an example embodiment may include one or more client devices (e.g., clients 20). Notably, although FIG. 1 illustrates three clients 20, it should be appreciated that a single client or many more clients 20 may be included in some embodiments and thus, the three clients 20 of FIG. 1 are simply used to illustrate a potential for a multiplicity of clients 20 and the number of clients 20 is in no way limiting to other example embodiments. In this regard, example embodiments are scalable to inclusion of any number of clients 20 being tied into the SFP platform 10. Furthermore, in some cases, some embodiments may be practiced on a single client without any connection to the SFP platform 10.

The clients 20 may, in some cases, each be associated with a single individual or customer. However, in some embodiments, one or more of the clients 20 may be associated with an organization (e.g., a company) or group of individuals (e.g., a family unit). In general, the clients 20 may be referred to as members of the environment or community associated with the SFP platform 10.

Each one of the clients 20 may include one or more instances of a communication device such as, for example, a computing device (e.g., a computer, a server, a network access terminal, a personal digital assistant (PDA), radio equipment, cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients 20 as described below. In an example embodiment, the clients 20 may include or be capable of executing a client application 22 configured to operate in accordance with an example embodiment of the present invention. In this regard, for example, the client application 22 may include software for enabling a respective one of the clients 20 to communicate with the network 30 for requesting and/or receiving information and/or services via the network 30 as described herein. The information or services receivable at the client applications 22 may include deliverable components (e.g., downloadable software to configure the clients 20, or information for consumption/processing at the clients 20). As such, for example, the client application 22 may include corresponding executable instructions for configuring the client 20 to provide corresponding functionalities for sharing, processing and/or utilizing financial data as described in greater detail below. In an example embodiment, the client application 22 may be employed to request financing to make a purchase with a merchant or vendor, as described in greater detail below.

The network 30 may be a data network, such as one or more instances of a local area network (LAN), a metropolitan area network (MAN), a wide area network (WAN) (e.g., the Internet), and/or the like, which may couple the clients 20 to devices such as processing elements (e.g., personal computers, server computers or the like) and/or databases. Communication between the network 30, the clients 20 and the devices or databases (e.g., servers) to which the clients 20 are coupled may be accomplished by either wireline or wireless communication mechanisms and corresponding communication protocols.

In an example embodiment, devices to which the clients 20 may be coupled via the network 30 may include one or more application servers (e.g., application server 40), and/or a database server 42, which together may form respective elements of a server network 32. Although the application server 40 and the database server 42 are each referred to as “servers,” this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the provision of access to information and/or services related to the SFP platform 10, and more particularly relating to facilitating transactions where the parties to the transaction are members of the ecosystem formed by the SFP platform 10. For example, the application server 40 may be configured to provide for storage of information descriptive of events or activities associated with the SFP platform 10 and the execution of a financial transaction on behalf of a customer in real time. In some cases, data and/or services may be exchanged amongst members, where specific needs or desires of the members are aligned with respect to playing their respective roles in connection with conducting a financial transaction using tools of the SFP platform 10 as described herein.

In some embodiments, for example, the application server 40 may therefore include an instance of a facilitation agent 44 comprising stored instructions for handling activities associated with practicing example embodiments as described herein. The facilitation agent 44 may be a technical device, component or module affiliated with the facilitator of the functioning of the SFP platform 10. Thus, the facilitation agent 44 may operate under control of the facilitator to be a technical means by which to carry out activities under direction of the facilitator or employees thereof. As such, in some embodiments, the clients 20 may access the SFP platform 10 services, and more particularly contact the facilitation agent 44 online and utilize the services provided thereby. However, it should be appreciated that in other embodiments, an application (e.g., the client application 22) enabling the clients 20 to interact with the facilitation agent 44 (or components thereof) may be provided from the application server 40 (e.g., via download over the network 30) to one or more of the clients 20 to enable recipient clients to instantiate an instance of the client application 22 for local operation such that the facilitation agent 44 may be a distributor of software enabling members or parties to participate in operation of the SFP platform 10. Alternatively, another distributor of the software may provide the client 20 with the client application 22, and the facilitation agent 44 may communicate with the client 20 (via the client application 22) after such download to execute functionalities described herein in a client/server relationship.

In an example embodiment, the client application 22 may therefore include application programming interfaces (APIs) and other web interfaces to enable the client 20 to conduct business or transactions via the SFP platform 10. The client application 22 may include a series of control consoles or web pages including a landing page, onboarding services, activity feed, account settings (e.g., user profile information), transaction management services, payment management services and the like in cooperation with a service application that may be executed at the facilitation agent 44. Thus, for example, the client application 22 may be a web application or website that may enable the customer to review monthly statements, request a loan, change settings associated with parameters or terms of the loan, make payments, access or adjust information associated with the customer account, or receive help or other information. Budgeting tools and other useful information and other useful tools for managing the finances of the customer may also be available via the client application 22 in some cases.

In an example embodiment, the application server 40 may include or have access to memory (e.g., internal memory or the database server 42) for storing instructions or applications for the performance of various functions and a corresponding processor for executing stored instructions or applications. For example, the memory may store an instance of the facilitation agent 44 configured to operate in accordance with an example embodiment of the present invention. In this regard, for example, the facilitation agent 44 may include software for enabling the application server 40 to communicate with the network 30 and/or the clients 20 for the provision and/or receipt of information associated with performing activities as described herein. Moreover, in some embodiments, the application server 40 may include or otherwise be in communication with an access terminal (e.g., a computer including a user interface) via which individual operators or managers of the entity associated with the facilitation agent may interact with, configure or otherwise maintain the SFP platform 10 and/or the facilitation agent 44.

As such, the environment of FIG. 1 illustrates an example in which provision of content and information associated with the financial industry (e.g., including at least some data provided to/from customers and/or vendors in real-time) may be accomplished by a particular entity (namely the facilitation agent 44 residing at the application server 40). Thus, the facilitation agent 44 may be configured to handle provision of content and information associated with tasks that are associated only with the SFP platform 10. Access to the facilitation agent 44 may therefore be secured as appropriate for the individuals or organizations involved and credentials of individuals or organizations attempting to utilize the tools provided herein may be managed by digital rights management services or other authentication and security services or protocols that are outside the scope of this disclosure.

The SFP platform 10 may also operate in cooperation with a bank authentication agent 50, an issuing bank agent 55, a merchant client 60, a customer bank agent 70, and a payment processor 80. The facilitation agent 44 may be configured to interact with, or otherwise facilitate interactions between, each of the bank authentication agent 50, the issuing bank agent 55, the merchant client 60, the customer bank agent 70, and the payment processor 80 in order to carry out example embodiments as described herein. Thus, each of the bank authentication agent 50, the issuing bank agent 55, the merchant client 60, the customer bank agent 70, and the payment processor 80 should be understood to be a computer, server, smart phone, or other technical component or module associated with a respective party (e.g., an authenticating bank, issuing bank, a vendor, a customer bank, and a payment service, respectively) that is capable of communication with other parties via the network 30, and under control of or responsive to facilitating communication by the facilitation agent 44.

The merchant client 60 may be similar to the client 20 described above, in some cases, except that the merchant client 60 may be associated with a merchant or vendor instead of a customer. The merchant client 60 may therefore also include a downloadable client application (e.g., merchant client application 62) similar to the client application 22 described above. However, the function of the merchant client application 62 may further interface with the facilitation agent 44 as described in greater detail below in order to handle onboarding of the merchant into the ecosystem of the SFP platform 10, and further integration of the merchant thereafter.

The issuing bank may be a bank or other financial services provider. The issuing bank may have a persistent relationship with the entity associated with the facilitation agent 44 (e.g., the facilitator), but generally need not have any persistent or pre-existing relationship with the customer or the customer bank. The issuing bank may be contracted with or otherwise have a pre-existing relationship with the facilitation agent 44 (and entity associated therewith) that enables the facilitation agent 44 to facilitate transactions on behalf of the customer when certain conditions (agreed upon in advance by the entity associated with the facilitation agent 44 and the issuing bank) are met associated with a transaction undertaken (or attempted) by the customer via the client 20 and client application 22. For example, the issuing bank may be the issuer of credit to the customer on behalf of the facilitation agent 44 and be responsible for directly paying the merchants and vendors during a transaction initiated by the customer via the operation of the SFP platform 10.

The bank authenticator may be an agent or financial service provider capable of granting the facilitation agent 44 access to the customer bank to view account balances and credentials. The balances and credentials may be used or relied upon to pull or push funds from or to the customer bank using the payment processor 80. Thus, for example, the bank authenticator may utilize its own software, application programming interfaces (APIs) or the like that define an infrastructure or intermediary platform to connect a customer's bank account with the facilitation agent 44.

The customer bank may be a bank at which the customer (i.e., associated with one of the clients 20) deposits money in a bank account such as a savings account or a checking account. In an example embodiment, the customer may apply via the facilitation agent 44 to enroll as a member of the SFP platform 10 and enable the customer to make purchases via transactions arranged in association with the facilitation agent 44 using, for example, online payment processing, a virtual card, a physical credit or debit card, or other payment card or method where the facilitator arranges for the issuing bank to issue a loan (e.g., an installment loan or conventional loan) to the customer and advances funds to the merchant associated with the merchant client 60 on behalf of the customer. During application, subscription or registration for the SFP platform 10, the customer may be prompted (via the client 20 and client application 22) by the facilitation agent 44 to provide account details identifying the savings account or checking account (i.e., a customer account) at the customer bank. The customer may, by registering or subscribing, further authorize the facilitation agent 44 to conduct specific activities related to the customer account when corresponding conditions are met, which may be facilitated by one of or a combination of the bank authenticator and the issuing bank as described above. The activities may include checking account status (i.e., checking a current balance of funds deposited in the customer account) and/or authorizing withdrawal of funds from the customer account by the payment processor 80 in order to settle a transaction or make payments to the facilitation agent 44. Credit checks or other activities enabling the customer to be approved for issuance of the virtual card may then be accomplished by the facilitation agent 44.

The payment processor 80 may be an agent or service that facilitates the acceptance and/or sending of payments between parties online. Thus, for example, the payment processor 80 may utilize its own software, application programming interfaces (APIs) or the like that define an infrastructure or payment platform to connect businesses or companies to manage their businesses or transactions online. Payments may be provided to the merchant or vendor on behalf of the customer when making a purchase, and the corresponding amount of the purchase may be converted into a loan (e.g., an installment loan or other loan) for the customer. Payments may also or alternatively be made by the customer to service the loan via the payment processor 80.

The customer bank agent 70 may change for each respective one of the clients 20 (and therefore for each respective customer). Similarly, the merchant client 60 may change for each respective transaction since different vendors may be involved in different transactions involving the clients 20. In some examples, the bank authentication agent 50 and the payment processor 80 may remain the same entities across all transactions managed by the facilitation agent 44. However, the facilitation agent 44 could use different bank authentication agents in different geographic areas or jurisdictions, and the payment processor 80 may also change on the same bases. In some cases, the facilitation agent 44 may use different bank authentication agents 50 in order to ensure all customers' banks can be accommodated. For example, if the customer bank was not serviced by a first bank authentication agent, the facilitation agent 44 is configured to swap in a second bank authentication agent that would allow for servicing of the customer bank. Accordingly, the facilitation agent 44 is configured to swap each of the payment processors 80 and the bank authentication agents 50 under certain circumstances. For example, the bank authentication agent 50 may be swapped by the facilitation agent 44 if the bank authentication agent 50 is temporarily offline or if the bank authentication agent 50 did not support a customer bank.

As noted above, the SFP platform 10 may operate to enable the customer associated with a given one of the clients 20 to make a purchase in real time from a merchant or vendor associated with the merchant client 60 either online or in-store using payment method arranged by the facilitator for the customer. In some example embodiments, the client application 22 may be used in connection with setting up the account details that are then used as the basis for managing interactions between the parties shown in FIG. 1 under control of the facilitation agent 44. In this regard, for example, the client application 22 may be used to engage (e.g., via a website and corresponding APIs) with the facilitation agent 44 to set up an account with the facilitation agent 44 for services associated with the SFP platform 10. The facilitation agent 44 may prompt the client 20 to provide account details associated with the customer bank agent 70 and may provide terms and conditions (electronically or via mail or other communication means) that the customer may accept to establish a user profile and user account with the facilitation agent 44.

During establishment of the user account, the customer may provide an identification of the customer bank associated with the customer bank agent 70, and may also provide details for the savings or checking account that the customer maintains at the customer bank. The customer may also authorize the facilitation agent 44 to make real time (or anytime) checks on account status (e.g., account balance) or to make periodic routine checks of the same. Thus, for example, for each transaction, the facilitation agent 44 may be enabled to check the account balance of the customer. Alternatively or additionally, the facilitation agent 44 may make routine checks or snapshot looks at the account balance. For example, a check may be made every day at a certain time, every two or three days, or at other standard or random intervals. The account status of the customer bank may be used by the facilitation agent 44 in facilitating payment transactions, and determining credit limits or making credit extension decisions. In some cases, a similar process may also be followed for merchants or vendors to facilitate taking payments from or providing payments to merchants or vendors.

Regardless of how the transactions are initiated, the SFP platform 10 of FIG. 1 may be used before, during and after the time of the transaction in order to enable the facilitation agent 44 to set up the user account for a customer, make determinations necessary to initiate the transactions in real time responsive to initiation of the transaction, and facilitate enabling the customer and to determine the treatment of transactions thereafter. Each of these activities may have its own respective timing and communications that are facilitated by the facilitation agent 44. However, example embodiments may further effectively and efficiently manage the onboarding of merchants into the ecosystem as well. Thus, more merchants may become part of the ecosystem thereby enriching the experience for customers by enhancing the number of ecosystem participants and therefore the number of opportunities for advantageous engagement between members of the ecosystem. Notably, in some embodiments, support for transactions may not be limited only to merchants that are members of the ecosystem. However, by becoming an integrated member of the ecosystem, merchants may be enabled to offer more services, enhancements, offers, and enticements to customers. Thus, integrated merchants may be empowered to attract more customers through engagement enabled by the SFP platform 10 (e.g., via enhanced tool kits, information about customers, or access) than those who are not integrated. Thus, again, enriching the ecosystem provides improved outcomes for all members or participants in the ecosystem.

Among the empowering enhancements offered to integrated merchants mentioned above, the ability to provide prequalification information for merchant specific loans (and sometimes brand or product specific loans) to customers may be included. In this regard, for example, the facilitator (e.g., via the facilitation agent 44, and while the customer is one a website or application associated therewith) may dynamically and proactively produce one or more merchant-specific prequalification determinations for the customer, and inform the customer regarding the same. The customer may effectively, while in contact with the facilitator, be apprised of opportunities to obtain financing up to the prequalified amount (or amounts) listed when shopping with the corresponding merchants. Thus, instead of needing to get all the way to checkout with a corresponding one of the merchants with a virtual cart amount, and then attempt to get financing, the customer may begin the shopping experience with the confidence of knowing that the customer will likely be approved for financing using the facilitator's services at checkout with the merchant (or merchants) that had prequalified status indications provided to the customer while on the website or web application of the facilitator. This may drive customer satisfaction and brand loyalty, as noted above.

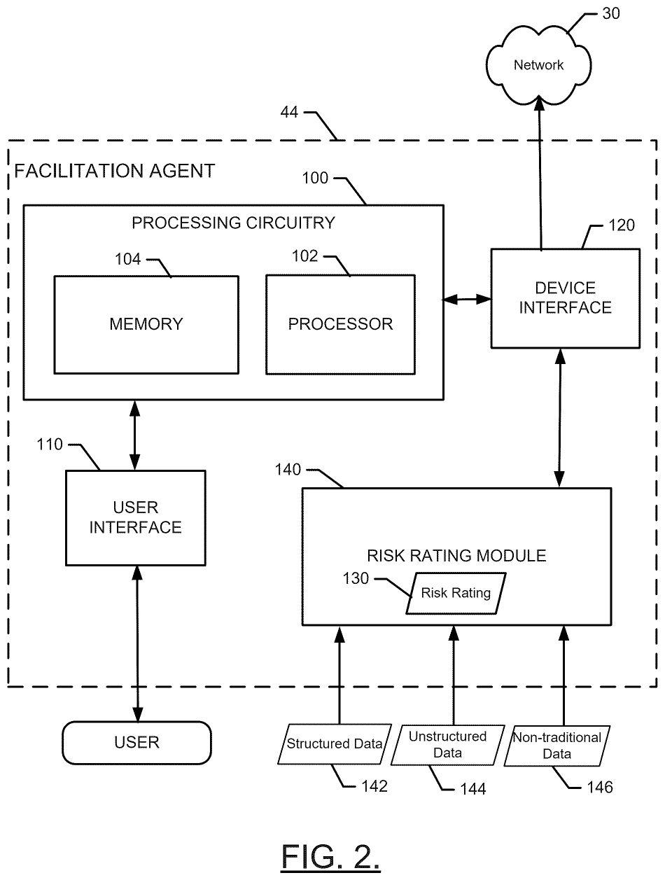

Other offers, sales or marketing events may also be supported by the SFP platform 10 for the merchant. However, the merchant client 60 of FIG. 1 is one example of a client associated with a merchant, which may be one of a multitude of merchants that may be part of the ecosystem described herein. Each individual merchant may have its own respective merchant risk both at the time of entry into the ecosystem, and at all times thereafter. Different merchant segments, industries, or other categorizations of merchants may be possible to make for the purposes of evaluating merchant risk, and those evaluations at any level may be of great use. However, the periodicity of evaluating merchant risk (and assigning a risk rating) may be limited by the processing power and efficiency of the resources available for employment. Moreover, selections of the types of information, or sources to use for risk rating may also be limited for practical purposes. Furthermore, as noted above, particularly for travel risk exposure (or DDD exposure) there has been no way to accurately estimate the risk in a way that is specific to each individual merchant. Instead, averages for the industry segment of the merchant have previously been broadly applied. Example embodiments may provide technical tools that use machine learning and artificial intelligence (AI) tools to rapidly expand the information sources that can be evaluated, the speed and efficiency of the evaluation, and therefore also the timeliness and effectiveness of the evaluation. Various examples of structures associated with an apparatus at which the facilitation agent 44 of an example embodiment may be instantiated will be described in reference to FIG. 2.

FIG. 2 shows certain elements of an apparatus for provision of the facilitation agent 44 or other processing circuitry that is capable of merchant risk assessment according to an example embodiment. The apparatus of FIG. 2 may be employed, for example, as the facilitation agent 44 itself operating at, for example, a network device, server, proxy, or the like (e.g., the application server 40 of FIG. 1)). Alternatively, embodiments may be employed on a combination of devices (e.g., in distributed fashion on a device (e.g., a computer) or a variety of other devices/computers that are networked together). Accordingly, some embodiments of the present invention may be embodied wholly at a single device (e.g., the application server 40) or by devices in a client/server relationship (e.g., the application server 40 and one or more clients 20/merchant clients 60). Thus, although FIG. 2 illustrates the facilitation agent 44 as including the components shown, it should be appreciated that some of the components may be distributed and not centrally located in some cases. Furthermore, it should be noted that the devices or elements described below may not be mandatory and thus some may be omitted or replaced with others in certain embodiments.

Referring now to FIG. 2, an apparatus for provision of tools, services and/or the like for facilitating an exchange for information and services associated therewith in the financial industry is provided. The apparatus may be an embodiment of the facilitation agent 44 or a device of the SFP platform 10 hosting the facilitation agent 44. As such, configuration of the apparatus as described herein may transform the apparatus into the facilitation agent 44. In an example embodiment, the apparatus may include or otherwise be in communication with processing circuitry 100 that is configured to perform data processing, application execution and other processing and management services according to an example embodiment of the present invention. In one embodiment, the processing circuitry 100 may include a storage device (e.g., memory 104) and a processor 102 that may be in communication with or otherwise control a user interface 110 and a device interface 120. As such, the processing circuitry 100 may be embodied as a circuit chip (e.g., an integrated circuit chip) configured (e.g., with hardware, software or a combination of hardware and software) to perform operations described herein. However, in some embodiments, the processing circuitry 100 may be embodied as a portion of a server, computer, laptop, workstation or even one of various mobile computing devices. In situations where the processing circuitry 100 is embodied as a server or at a remotely located computing device, the user interface 110 may be disposed at another device (e.g., at a computer terminal) that may be in communication with the processing circuitry 100 via the device interface 120 and/or a network (e.g., network 30).

The user interface 110 may be in communication with the processing circuitry 100 to receive an indication of a user input at the user interface 110 and/or to provide an audible, visual, mechanical or other output to the user. As such, the user interface 110 may include, for example, a keyboard, a mouse, a joystick, a display, a touch screen, a microphone, a speaker, augmented/virtual reality device, or other input/output mechanisms. In embodiments where the apparatus is embodied at a server or other network entity, the user interface 110 may be limited or even eliminated in some cases. Alternatively, as indicated above, the user interface 110 may be remotely located. For example, in some cases, the user interface 110 may be disposed at a remote device (e.g., the client 20/merchant client 60) and may therefore be operable through communication via the network 30.

The device interface 120 may include one or more interface mechanisms for enabling communication with other devices and/or networks. In some cases, the device interface 120 may be any means such as a device or circuitry embodied in either hardware, software, or a combination of hardware and software that is configured to receive and/or transmit data from/to a network (e.g., network 30) and/or any other device or module in communication with the processing circuitry 100. In this regard, the device interface 120 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 120 communicates with a network, the network 30 may be any of various examples of wireless or wired communication networks such as, for example, data networks like a Local Area Network (LAN), a Metropolitan Area Network (MAN), and/or a Wide Area Network (WAN), such as the Internet, as described above.

In an example embodiment, the memory 104 may include one or more non-transitory storage or memory devices such as, for example, volatile and/or non-volatile memory that may be either fixed or removable. The memory 104 may be configured to store information, data, applications, instructions or the like for enabling the apparatus to carry out various functions in accordance with example embodiments of the present invention. For example, the memory 104 could be configured to buffer input data for processing by the processor 102. Additionally or alternatively, the memory 104 could be configured to store instructions for execution by the processor 102. As yet another alternative, the memory 104 may include one of a plurality of databases (e.g., database server 42) that may store a variety of files, contents or data sets. Among the contents of the memory 104, applications (e.g., a service application configured to interface with the client application 22/merchant client application 62) may be stored for execution by the processor 102 in order to carry out the functionality associated with each respective application.

The processor 102 may be embodied in a number of different ways. For example, the processor 102 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 102 may be configured to execute instructions stored in the memory 104 or otherwise accessible to the processor 102. As such, whether configured by hardware or software methods, or by a combination thereof, the processor 102 may represent an entity (e.g., physically embodied in circuitry) capable of performing operations according to embodiments of the present invention while configured accordingly. Thus, for example, when the processor 102 is embodied as an ASIC, FPGA or the like, the processor 102 may be specifically configured hardware for conducting the operations described herein. Alternatively, as another example, when the processor 102 is embodied as an executor of software instructions, the instructions may specifically configure the processor 102 to perform the operations described herein.

In an example embodiment, the processor 102 (or the processing circuitry 100) may be embodied as, include or otherwise control the facilitation agent 44, which may be any means such as a device or circuitry operating in accordance with software or otherwise embodied in hardware or a combination of hardware and software (e.g., processor 102 operating under software control, the processor 102 embodied as an ASIC or FPGA specifically configured to perform the operations described herein, or a combination thereof) thereby configuring the device or circuitry to perform the corresponding functions of the facilitation agent 44 as described below.

The facilitation agent 44 may be configured to include tools to facilitate the creation of customer, merchant or user accounts (and a corresponding profile for each), the provision of tools to enable merchants to define marketing programs, incentives, sales, etc., the means by which customers can engage merchants to pay for services (e.g., financed by a loan such as an installment loan), and the coordination of communication and fund transfers to support the operations of the SFP platform 10 as described herein. The tools may be provided in the form of various modules that may be instantiated by configuration of the processing circuitry 100. Many of those tools may relate to aspects that are outside the scope of this disclosure, and therefore will not be discussed specifically herein. Instead, FIG. 2 illustrates some examples of modules that may be included in the facilitation agent 44 and that may be individually configured to perform one or more of the individual tasks or functions generally attributable to the facilitation agent 44 according to an example embodiment and relevant to the focus of this disclosure. However, the facilitation agent 44 need not necessarily be modular. In cases where the facilitation agent 44 employs modules, the modules may, for example, be configured to perform the tasks and functions described herein. In some embodiments, the facilitation agent 44 and/or any modules comprising the facilitation agent 44 may be any means such as a device or circuitry operating in accordance with software or otherwise embodied in hardware or a combination of hardware and software (e.g., processor 102 operating under software control, the processor 102 embodied as an ASIC or FPGA specifically configured to perform the operations described herein, or a combination thereof) thereby configuring the device or circuitry to perform the corresponding functions of the facilitation agent 44 and/or any modules thereof, as described herein.

Before a merchant account can be established such that the merchant having the corresponding merchant account may be considered to be an “integrated merchant” since the corresponding merchant is integrated into the ecosystem mentioned above, a risk rating 130 may need to be assigned and evaluated for the merchant. If the risk rating 130 of the merchant is below (or remains below) a threshold value of risk, the merchant may be added as an integrated merchant or may continue to function as such within the SFP platform 10. Notably, the risk rating 130 may be a value that is higher when risk is high, or higher when risk is low, dependent upon the paradigm chosen by the facilitator. The situation described above (i.e., requiring the risk rating 130 to be below the threshold value of risk) therefore corresponds to the risk rating 130 being high when the risk is high. However, if the opposite paradigm is chosen (i.e., the risk rating 130 being high when the risk is low), then the threshold value may need to be exceeded for the merchant to become an integrated merchant. Moreover, the risk rating 130 may also be calculated for merchants that are not integrated merchants in some cases. In this regard, example embodiments may be capable of determining the risk rating 130 for any merchant whose identity is sufficiently provide to enable the tools described in greater detail below to obtain corresponding information about the identified merchant(s).

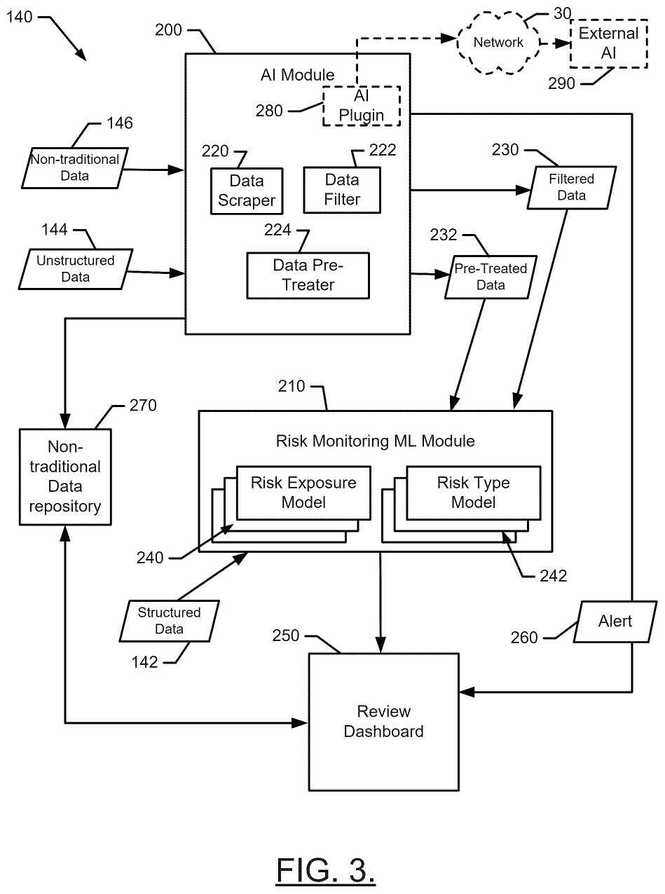

In order to assign the risk rating 130, the facilitation agent 44 may include or otherwise be operably coupled to a risk rating module 140. The risk rating module 140 may perform real time risk monitoring to allow initial determinations of the risk rating 130, and to continuously update the risk rating 130 in real time (or near real time). The risk rating module 140 may be configured, as discussed in greater detail below, to prioritize risks, provide consistent risk assessments that are accurate, and do so in the presence of (and using) massive amounts of rapidly changing and very diverse types of information that include each of structured data 142, unstructured data 144, and non-traditional data 146. Given the massive amounts of data involved, the changing nature of the data over time (including short time frames and long time frames), and the fundamental differences in the types of data that are being monitored, unique processing tools and methods must be employed. In particular, some example embodiments employ artificial intelligence (AI) tools including machine learning in order to provide the technical capability to, when employed as described herein, process the incoming data in real time to provide real time risk monitoring in this dynamic environment. The use of the AI tools in this context allows the non-traditional data 146, which is conventionally unusable, to be used and to dramatically improve the accuracy and relevancy of the determinations that are made on the basis of that information. In particular, dispute rates related to refund processing have been shown to decrease, and dispute escalations also decrease due to more accurate estimations that help to minimize future losses. In particular, the AI tools described herein provide qualitative methods of merchant credit sizing and money-at-risk sizing while employing machine learning and non-traditional data processing to significantly advance beyond current industry standards. FIG. 3 shows a block diagram of various components employed by the risk rating module 140 in order to accomplish this.

Referring now to FIG. 3, the risk rating module 140 may include an AI module 200 and a risk monitoring machine learning module 210. In an example embodiment, the AI module 200 may provide filtering and/or data pre-treatment for the non-traditional data 146 and the unstructured data 144. In this regard, for example, the AI module 200 may employ AI filtering to the non-traditional data 146, so that relevant data to the problem of classifying merchant risk may be extracted in real time. The non-traditional data 146 may include data that is not directly associated with the transactional operations of the corresponding merchant to which the non-traditional data 146 applies. Thus, whereas financial statements, disputes, complaints, transaction data, and other financial performance data clearly relate to the transactions the merchant engages in, other information such as public ratings, social media posts, news articles and/or the like, may not directly relate to the transactional operations of the corresponding merchant, but may still offer clues as to the merchant risk. For example, if the merchant receives low public ratings for inability to reach a person to resolve an issue, the public rating may be indicative of the merchant being understaffed, or otherwise poorly managed. This may ultimately indicate (or lead to) increased merchant risk. The opposite may be true if public ratings are very high. Similarly, if social media posts indicate that the business appears to be shuddered, closed or otherwise non-operational, the posts may provide advanced clues that the merchant is going out of business and merchant risk is therefore very high.

Notably, whereas the public ratings are likely always written, the social media posts and news articles could be written, in video/audio form, images, etc. Thus, the AI module 200 may include both text-based filters and image-based filters. Audio files may be converted to text prior to text-based filtering, and video files may be segmented into images for image-based filters, and the audio may be converted to text for text-based filtering as noted above. Natural language processing (NLP) may then be employed with respect to text-based filtering using machine learning modules trained to identify specific situations, events, or information that may indicate elevated exposure in any of various categories.

In some cases, the AI module 200 may further include a data scraper 220 that may scrape data from various identified sources for the public ratings, social media posts, news articles and/or the like. The data scraper 220 may be embodied as a large language model (LLM) that is used in connection with generating filtered data 230. The LLM (e.g., ChatGPT or other GPT models, etc.) may include an AI accelerator that processes vast amounts of the non-traditional data 146 and applies weights (e.g., from millions to billions of such weights) to the data received using trained neural networks that effectively enable removal of low quality data, duplicated data, and other non-useful data, thereby leaving the filtered data 230 as a high quality and much smaller dataset for further processing. The filtered data 230 may be output from the AI module 200 corresponding to the non-traditional data 146 that is considered relevant to merchant risk, and which should be considered by the risk monitoring machine learning module 210.

The AI module 200 may also pre-treat the unstructured data 144 so that the unstructured data 144 can be provided in a form that can be processed by the risk monitoring machine learning module 210. The unstructured data 144 may include data that is directly associated with the transactional operations of the corresponding merchant, but which is not structured for exposure determination by the risk monitoring machine learning module 210. Thus, for example, the unstructured data 144 may include dispute content, complaint content, financial statements, and/or the like. Dispute content and complaint content may include data that is indicative of customer disputes and complaints and may include either simply the fact of such events, or also include information about the resolution of such events. The fact of the events alone may be pertinent to merchant risk, especially when the fact of the events can be quantified in terms of a frequency metric or a likelihood of happening. A merchant with a high rate of drawing complaints or engaging in disputes may typically also have a higher likelihood of having a high merchant risk. The AI module 200 may provide pre-treatment of the unstructured data 144 to generate pre-treated data 232 that may be output to the risk monitoring machine learning module 210. In some embodiments, the pre-treatment may identify relevant information to merchant risk from the unstructured data, and may also provide the pre-treated data 232 to the risk monitoring machine learning module 210 in a form that is fit for use by the risk monitoring machine learning module 210.

The structured data 142 may include data that is directly associated with the transactional operations of the corresponding merchant, and is already structured for exposure determination by the risk monitoring machine learning module 210. Thus, for example, the structured data 142 may already be in a form that is suitable for consumption and use by the risk monitoring machine learning module 210. Accordingly, the structured data 142 (and only the structured data 142) may be provided directly to the risk monitoring machine learning module 210.

In an example embodiment, the risk monitoring machine learning module 210 may receive the structured data 142, the pre-treated data 232 and the filtered data 230 and determine exposure risk associated with multiple different types of exposure and/or multiple different types of risk. Thus, for example the risk monitoring machine learning module 210 may actually include sub-models or modules that deal with each respective one of different types of exposure. As noted above, the term “exposure” may be defined as the monetary value (e.g., dollar value) at risk that a merchant is not able to fulfill due to various reasons (e.g., fraud, bankruptcy, shutdown, etc.). Exposure may be broken down into different parts or types including, for example, dispute exposure, refund exposure, and travel exposure (or delayed delivery days (DDD) exposure).

Dispute exposure may represent the risk that the merchant will be unable to handle disputes that are the fault of the merchant. A flow rate calculation may be useful for determining dispute exposure based on merchant segments by volume. The flow rate calculation may represent the exposure based on a percentage of loans that have disputes associated therewith times the median or average amount of the loans. Dispute exposure may be computed at the merchant level or at the industry level, and may be based on the volume of loans for the merchant (or all merchants in an industry or segment). Refund exposure may represent the risk that the merchant initiates a refund to a customer, but does not actually reverse payment to the facilitator (or lender). Calculation of the refund exposure may be accomplished via a catboost classifier model that generates a refund probability for each loan. The refund exposure may then be calculated as the refund probability times the loan amount for each loan having a probability greater than zero summed over a given period of time (e.g., 30 days). The travel exposure may represent the non-delivery risk of goods or services in case of a merchant default. Other types of exposure risk may also be calculated, in some cases, with respective different models and calculations associated with each one. In FIG. 3, a plurality of risk exposure models 240 are illustrated and each respective one of the risk exposure models 240 may be configured to determine risk exposure for a different type of exposure risk (e.g., travel exposure, refund exposure, dispute exposure, etc.).

The exposure risk generally correlates risk to a monetary value, but risk may also be calculated in terms of likelihood without necessarily invoking a monetary value. Thus, for example, the risk monitoring machine learning module 210 may further include separate models or calculators for determining merchant credit risk (e.g., the risk that the merchant will go bankrupt), merchant fraud risk (e.g., the risk that the merchant is a fraudster), operational risk (e.g., the risk associated with bad business practices), compliance risk (e.g., the risk that the merchant is selling prohibited products), collusion risk (e.g., the risk that merchants and buyers are colluding in a scheme), etc. For each respective risk calculation or exposure risk calculation, the AI module 200 and/or the risk monitoring machine learning module 210 may use AI and ML tools tailored to identifying the corresponding risks and filtering or treating data to facilitate identification of the same. In FIG. 3, a plurality of risk type models 242 are illustrated and each one of the risk type models 242 may correspond to a respective different type of risk (e.g., merchant credit risk, merchant fraud risk, operational risk, compliance risk, collusion risk, etc.).

Each of the risk type models 242 relates to a corresponding different risk, and therefore has corresponding different inputs or signals that are applied to the respective models to get the output risk rating for the corresponding type of risk. Similarly, each of the risk exposure models 240 relates to a corresponding different exposure, and therefore also has corresponding different inputs or signals that are applied to the respective models to get the output exposure or risk rating for each corresponding type of exposure. The structured data 142 is already in a form that feeds into each respective model, and therefore needs no filtering or formatting. Thus, the structured data may be fed directly into the risk monitoring machine learning module 210 without any pre-processing or filtering.

The non-traditional data 146, however, is a both not directly related to risk monitoring in its many native forms, and also extremely voluminous. Accordingly, the non-traditional data 146 needs significant filtering (since the volume of information is immense) to identify relevant information that is more manageable for further processing. When filtering is completed, the relevant information then also needs formatting as well. To accomplish the dual functions of filtering and formatting, a data filter 222 may be provided. The data filter 222 may apply AI tools for filtering, and may thereafter format the data that has been filtered to produce the filtered data 230. The filtered data 230 may include signals in a form or structure that enables the models of the risk monitoring machine learning module 210 to generate a risk rating.

The unstructured data 144 generally includes relevant information to the making of financial determinations. Since the unstructured data is generally relevant, AI tools for filtering are not necessarily required. However, AI tools may be useful for properly formatted for the unstructured data 144 for application to the models of the risk monitoring machine learning module 210. A data pre-treater 224 may therefore be provided at the AI module for pre-treating the unstructured data 144 such that pre-treated data 232 that is output by the data pre-treater 224 may include signals in a form or structure that enables the models of the risk monitoring machine learning module 210 to generate a risk rating. Notably, in some cases, certain data could be considered to be both unstructured data 144 and non-traditional data 146. In such cases, both the data filter 222 and the data pre-treater 224 may operate on the data and the resultant filtered data 230 and pre-treated data 232 may be combined into a single output that is fed to the risk monitoring machine learning module 210.

The risk monitoring machine learning module 210 may utilize all of its models to generate component risk ratings that associate with each respective different risk exposure or risk type. The risk monitoring machine learning module 210 may also sum or otherwise accumulate all of the component risk ratings into a composite risk rating for the merchant. A similar accumulation may be accomplished for a group of merchants, an industry or an industry segment. In an example embodiment, the risk monitoring machine learning module 210 may also be configured to employ machine learning to self-learn and improve the risk rating determinations it makes over time. In some embodiments, the risk monitoring machine learning module 210 may employ a queuing algorithm (or algorithms) for driving an output that can be reviewed by a reviewer (or operator) of the facilitator.

In an example embodiment, the various models of the risk monitoring machine learning module 210 may be trained models that are also updateable during operation for further learning and modification. Via the trained models, the risk monitoring machine learning module 210 may be configured to determine merchant risk in a manner that can be utilized by the facilitator to determine whether to extend credit to merchants, and facilitate provision of marketing events, offers, sales or other marketing activities in conjunction with the merchants.

In an example embodiment, a review dashboard 250 may be included to provide an interface (e.g., via user interface 110 or something similar thereto) for a reviewer of the facilitator to interact with the facilitation agent 44 and receive the output from the queuing algorithm. The review dashboard 250 may, in some cases, receive an alert 260 from the AI module 200 if certain information appears to indicate a concerning situation or trigger event (or review event) associated with the merchant. For example, if social media posts indicate that the merchant has shuttered its doors, is selling prohibited goods, or has hit other defined triggers, the alert 260 may be provided directly to the review dashboard 250. In some embodiments, when the non-traditional data 146 is filtered, and relevant data is identified, original content associated with the relevant data may be stored at a non-traditional data repository 270 (which may be part of the memory 104). When the alert 260 is received at the review dashboard 250, the alert 260 may include an identification of the relevant data and a link or other identifier that enables the reviewer to access the original content from the non-traditional data repository 270. Thus, for example, if the relevant data that caused the trigger event was a suggestion that the merchant has ceased operations, the reviewer may access an original image of the front door of the merchant with a sign indicating permanent closure, or a blog or other social media posting indicating that the business is or appears to be permanently closing its doors.

Notably, image data and social media posts are both voluminous (as noted above), and not formatted for merchant risk calculation under normal circumstances. Meanwhile, AI tools (e.g., ChatGPT) can relatively accurately and quickly identify relevant information when directed appropriately. Thus, for example, the facilitator may define a plurality of trigger events (or review events) for which the data scraper 220 may sift through massive amounts of information to find evidence of such trigger events. In this regard, again for example, if the facilitator is concerned about the sale of prohibited goods (e.g., guns, alcohol, etc.), the trigger event may be defined by a text based question, “Is the merchant selling [insert name or prohibited good]?”. The AI tools (e.g., ChatGPT) may scour the internet to determine whether any relevant information surfaces for this question employing NLP, image recognition and other tools to provide relevant results. Similarly, if the facilitator is concerned about product return behavior, merchant legal disputes, merchant accessibility, prohibited goods sales, financial health of the merchant, etc., a list of trigger events may further be defined for each respective one of these concerns (and many more) with corresponding questions or other prompts that the AI tools may use as prompts to scrape and then filter data to ensure results are formatted properly for presentation to system models.

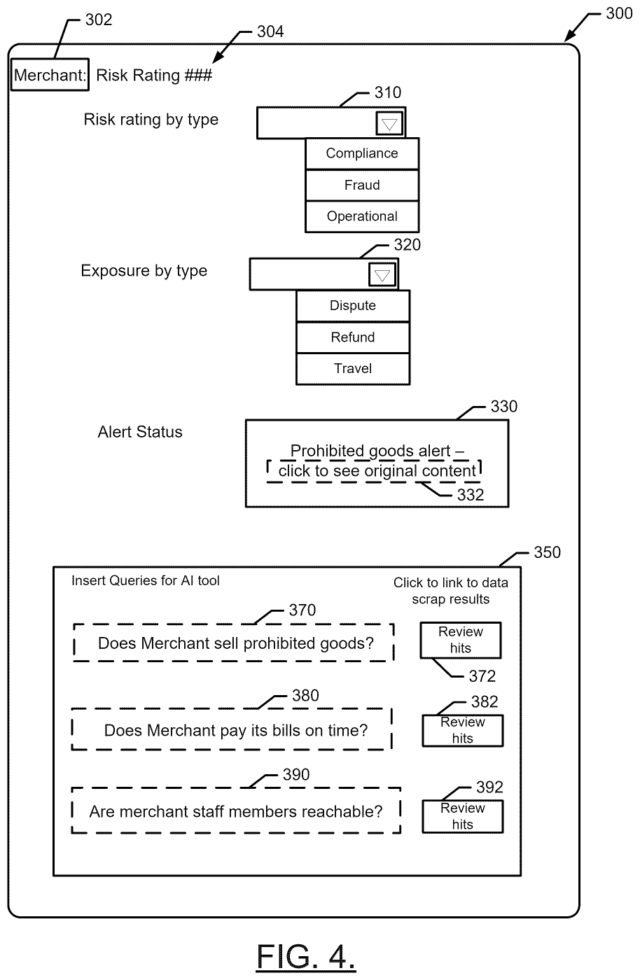

FIG. 4 illustrates a display associated with an example dashboard 300 in accordance with an example embodiment. The dashboard 300 may include a merchant selector 302, which may include a drop down menu or other entry mechanism by which to enter or select a merchant name. The risk rating 304 for the merchant selected may be illustrated on the dashboard 300. In some cases, the risk rating 304 may be a composite value, and components of the composite value may be selected or modified (e.g., by changing models) via a risk type selector 310 and/or an exposure type selector 320. Various selectable options within each category may be provided responsive to selection of the selectors.

In some cases, the dashboard 300 may include, either on the same screen or a different one, an alert display 330. The alert display 330 may provide an indication of the existence of the alert 260 and, in some cases, identifying information or further context information about the alert 260. In some cases, the alert display 330 may also include a link 332 to original or raw content that, after AI tool processing or filtering, caused the alert 260 to be issued. In some cases, as noted above, a separate screen for interacting with alert status information may be provided, and/or a separate screen may be provided for viewing the original content when selected.

In an example embodiment, the dashboard 300 (again either on the same or on a different screen) may include tools for provision of queries for the AI tool, which may serve as event triggers or review triggers for the non-traditional data 146. Interface window 350 may provide multiple query insertion windows 370, 380 and 390, which may each be used by the reviewer to insert natural language inquiries that define review triggers for the AI tools to search for. Selection options 372, 382 and 392 may correspond to each of the queries in the query insertion windows 370, 380 and 390, respectively, in order to enable the reviewer to retrieve and review respective hits that are returned for each query.

Returning now to FIG. 3, it is noteworthy that although the AI module 200 may include tools that are locally housed by the facilitator, in some cases the processing load associated with AI tools may instead essentially be outsourced to publicly available tools accessible via the network 30. In this regard, for example, FIG. 3 further illustrates that the AI module 200 may include an AI plugin 280 that allows access to external AI tools 290 via the network 30. Thus, for example, the AI plugin 280 may include software tools for defining the trigger events or review events, and for accessing external LLM, ChatGPT, or other external AI sources that are used to scrape data corresponding to the trigger events defined. The use of the AI plugin 280 may dramatically reduce processing load on the resources of the facilitator without suffering any noticeable reduction in processing speed or accuracy. In such cases, formatting in order to get signals usable by the models of the risk monitoring machine learning module 210 may still be employed locally at the AI module 200. However, some data scraping and filtering may be accomplished using external resources.

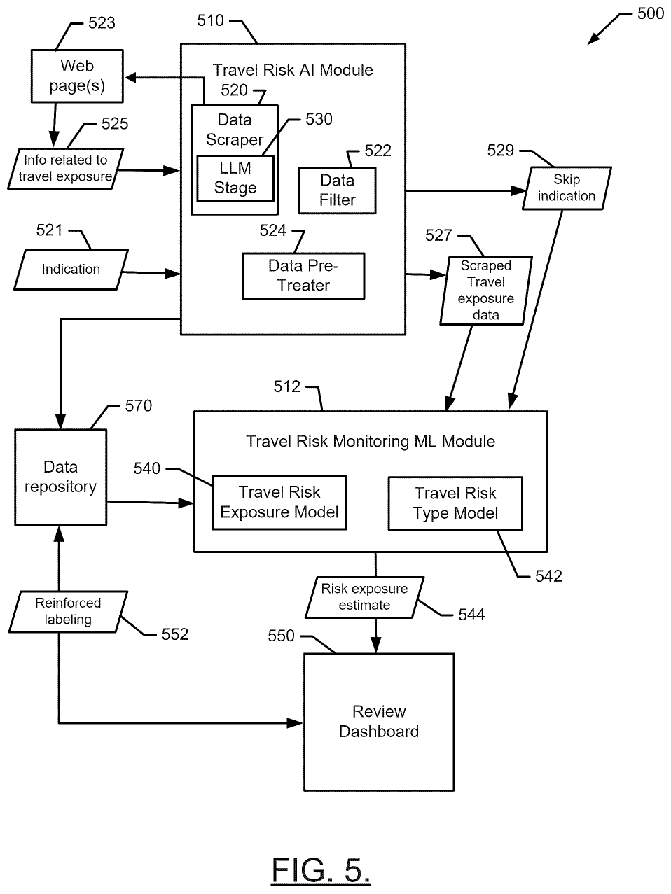

The risk rating module 140 of FIG. 3 can, as shown therein, operate with respect to various different types of risk and corresponding risk exposure based on the inclusion of multiple risk exposure models 240 and risk type models 242 that are tailored to the individual types of risk and exposure. However, one particular type of risk has proven extremely difficult to deal with in the past, as noted above. In this regard, travel risk and corresponding travel exposure (or DDD exposure) have been extremely difficult to estimate given the diversity of data and information from which this information would potentially be gleaned. Thus, travel exposure tends to have the least structured (or most unstructured) data to examine, and can also have the widest variance between signals and indicators associated with different types of travel exposure. Meanwhile, travel exposure is typically the most significant risk contributor to any overall merchant risk determination and, in some cases, may account for 70% or more of the total risk. Accordingly, in an example embodiment, the risk rating module 140 of FIG. 3 may be further modified in particular in relation to travel risk and travel exposure. FIG. 5 demonstrates a block diagram of such a travel risk rating module 500, which may be specifically upgraded for performance with respect to determining or predicting merchant risk due to enhanced capability with respect to travel risk and travel exposure determination.

The travel risk rating module 500 may include a travel risk AI module 510 and a travel risk monitoring machine learning module 512 that are similar to the AI module 200 and risk monitoring machine learning module 210 of FIG. 3 above, except that they are modified specifically for improved travel risk and exposure determination. Thus, for example, whereas the travel risk AI module 510 includes a travel data scraper 520, travel data filter 522 and travel data pre-treater 524 similar to data scraper 220, data filter 222 and data pre-treater 224 discussed above, the travel data scraper 520, travel data filter 522 and travel data pre-treater 524 of FIG. 5 receive more specific inputs described, and process them more specifically as described herein.

In this regard, the travel data scraper 520 may receive an indication 521 of a merchant under consideration. The indication 521 may include a name, address, website, or any other accurate and unambiguous way to identify the merchant under consideration. The travel data scraper 520 may then conduct a query based on the indication 521 to find one or more web pages 523 that can be determined (e.g., based on form and structure of the web pages 523 or other clues) or at least is most likely to include information related to travel exposure 525. The information related to travel exposure 525 may include, for example, itinerary data (for merchants in the travel industry), shipping information (for merchants in industries that deliver products) and/or return policy information (for merchants that deliver goods or services that are refundable) for the merchant under consideration. Having found the correct web page or web pages 523 to examine, the travel data scraper 520 may go to the URL(s) or otherwise visit the web page(s) 523 and further analyze the data and/or information that is presumed to define the information related to travel exposure 525 (e.g., itinerary data, shipping and/or return policy information) for the merchant under consideration. In particular, in some example embodiments, the travel data scraper 520 may apply a large language model (LLM) stage 530 to the contents of the web page or web pages 523 identified as most likely to include information related to travel exposure 525.

The LLM stage 530 may include one or more LLMs or other AI tools that are configured to quickly determine the intent of the contents of the web page(s) 523 and identify segments of the contents that may (e.g., based on determined intent) include, for example, itinerary information, shipping information, return policy information and/or the like. The LLM stage 530 may include one or more LLMs that may each be tailored to a particular form of content. The tailoring may include reinforced learning from human feedback (RLHF) aimed at allowing the LLM stage 530 to process websites and webpages in various formats and locations such as shipping policies, frequently asked questions (FAQs), product pages indicting shipping times, delivery schedules, delivery promises associated with marketing materials, adds or promotions, etc. In this regard, for example, the information used to determine intent may be buried in text, in charts or graphics of various types and forms, or in combinations thereof and on different pages. Moreover, in some cases, the information may be coded or conveyed in jargon that is unique to a particular merchant, industry segment, or the like. Thus, the LLM stage 530 may include one or more LLMs for each type or form of information conveyance (e.g., text, chart, graphic, etc.) and each of the LLMs may run separately in parallel to try to determine whether any of the contents being examined include information associated with the corresponding form of information conveyance that appears to be indicative of information related to travel exposure 525. For each form of information conveyance, the corresponding LLM or LLMs may output a confidence score relative to any information extracted therefrom being indicative of information related to travel exposure and, if the confidence score is high enough, the corresponding extracted information may be processed as if it includes information indicative of travel exposure (e.g., being filtered, pre-treated or otherwise treated) so it can be applied to the travel risk monitoring machine learning module 512 as scraped travel exposure data 527.

In some cases, the LLM stage 530 may employ a two-step scraping process including keyword-based scraping and fallback scraping. The keyword-based scraping may include target sub-domains containing specifically targeted words such as, for example, “shipping,” “return,” “departure,” and/or the like along with other keywords that identify temporal limitations in days, weeks, etc. In this context, the specifically targeted words are words that effectively define a flag indicating a relationship to a travel exposure topic for an industry segment. For example, for the travel industry, terms related to the travel experience and specifically likely to be included in an itinerary or other travel related experiences may be targeted. Meanwhile, for industries involving the provision of goods, terms that identify when and how the product will be shipped, delivered, returned or otherwise processed may be used as targeted words. The fallback scraping may be accomplished over predefined sections of a website, and define a scraping depth for situations where no clear DDD or travel exposure keywords or other indicators have otherwise been clearly identified. For example, a crawl depth of 5 and a maximum number of pages of 40 could be used to limit scraping to the top 40 pages, at a depth of five. Thus, any depth and any number of pages, including defining ranges of pages within or at the front or back of a site can be achieved.

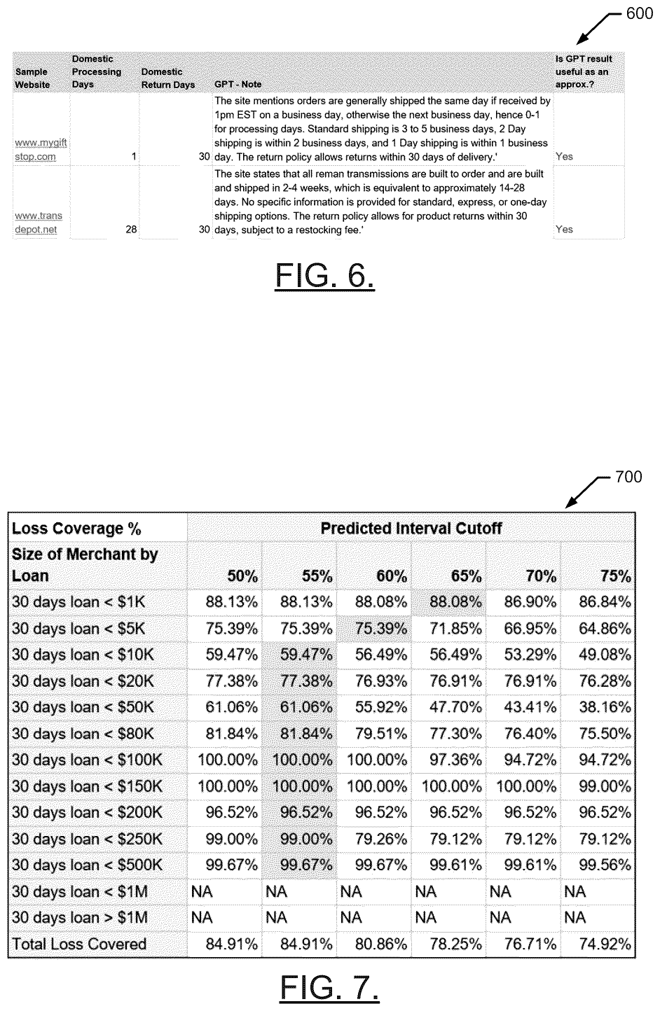

The LLM stage 530 may also standardize outputs by employing structured data extraction and outlier management. For example, structured data extraction may utilize LLMs for initial structured data extraction be defining a response schema that names and describes data that is to be output. FIG. 6 illustrates one form (e.g., table 600) of structured output that may be employed in an example embodiment. Outlier management may apply algorithms to manage outliers and convert results provided in formats that are temporally organized (e.g., weeks, days, business days, etc.) to assist in standardizing the output of the scraped travel exposure data 527.

The scraped travel exposure data 527 may be filtered and/or pre-treated along the lines discussed above in connection with describing FIG. 3 in some cases. However, in situations where the LLM stage 530 is unable to provide any information extraction of potential information related to travel exposure having a confidence score above a threshold value, then it may not be possible to provide the scraped travel exposure data 527. A skip indication 529 or absence of the scraped travel exposure data 527 may communicate to the travel risk monitoring machine learning module 512 that there is no scraped travel exposure data 527 worthy of provision. The travel risk monitoring machine learning module 512 may then manage its operations accordingly.

In this regard, for example, regardless of whether the travel risk monitoring machine learning module 512 receives the scraped travel exposure data 527 or the skip indication 529 it may be presumed that the risk exposure model 240 employed would be a travel risk model 540. The risk type model 242 may be employed for each type of risk as outlined above as well. However, particularly for travel exposure determinations, the travel risk monitoring machine learning module 512 may participate in further activity that may effectively employ a hierarchical exposure methodology that attempts to sequentially employ different exposure determination operations that are handled in order of resultant accuracy. In this regard, the travel risk monitoring machine learning module 512 attempts first to employ the most accurate method of determining exposure risk available (e.g., using the scraped travel exposure data 527), and then sequentially cycles through the next highest accuracy method available until finally arriving at a simple default value that can be applied if no other option is available.

In some embodiments, the highest accuracy exposure risk determining method may be one that successfully employs the scraped travel exposure data 527. In this regard, the scraped travel exposure data 527 typically includes itinerary data, shipping policy information, return policy information, or other information that specifically informs travel risk rating module 500 detailed information about the time between placing an order and receiving the product or service ordered. The time in between is the time that money advanced to purchase the product or service ordered is at risk if, for example, the product or service ordered is never delivered. For travel services, the itinerary data provides the exact dates and times of interest for determining the risk, potentially along with extra information about the mode of travel, accommodation type, location, brand name, etc., all of which may be useful for determining travel exposure risk. Historically, signals providing this type of information have not been able to be extracted and accuracy for this type of risk could not accurately be determined. However, using example embodiments, it is currently estimated that coverage of this type of exposure is about 10% of all travel risk. By employing the travel risk rating module 500 described herein, particularly when the travel risk AI module 510 is able to produce the scraped travel exposure data 527 based on itinerary information, accuracy of the information used for risk modeling can be increased to basically 100%. Thus, nearly 100% accuracy can be achieved nearly 10% of the time, whereas that 10% of scenarios had previously only been estimable using low accuracy default or industry standard estimates.

For shipping policy and/or return policy information, coverage is typically around 35%, and historically only industry standard labels could be used to apply generic guesses or default values, thereby resulting in low accuracy most of the time (i.e., nearly 35% of the time). By employing the travel risk rating module 500 described herein, particularly when the travel risk AI module 510 is able to produce the scraped travel exposure data 527 based on shipping policy and/or return policy information scraped, accuracy of the information used for risk modeling can be increased to about 96%. Thus, the ability to add new signals in the analytical realm, previously entirely absent and unobtainable, makes a massive difference in the accuracy of follow-on risk calculations and determinations. Without example embodiments, as many as 45% of all cases would be subject to default guesses regarding travel risk exposure or industry standard assigned values having low accuracy. However, by employing example embodiments, nearly 45% of the time greater than 96% accuracy can be expected. Thus, if the travel risk monitoring machine learning module 512 receives the scraped travel exposure data 527 (indicating new signaling was evaluated successfully), the travel risk model 540 (e.g., along with a corresponding travel risk type model 542) can generate highly accurate risk estimations, accuracy of any risk exposure estimate 544 generated therefrom may be expected to be well in excess of 96%.

When the skip indication 529 is received or there is otherwise no scraped travel exposure data 527, accuracy of information may be reduced, and a next hierarchical level of analysis may be employed. In this regard, for example, accuracy of exposure risk estimation can also be increased in relation to operator interaction and labeling which may populate the data repository 570. Typically, human labeling efforts may be applied with about 30% coverage. By employing review dashboard 550 and feedback from an operator to provide reinforced labeling 552 to initiate human labeling with prediction machine learning by the travel risk monitoring machine learning module 512, accuracy of travel risk exposure estimates can be pushed as high as about 90% for risk exposure estimate 544. Thus, in combination with the highest level of hierarchical risk assessment (e.g., by the combination of the travel risk AI module and the travel risk monitoring machine learning module 512 working together) nearly 45% of cases will be handled with higher than 96% accuracy. At the second level of hierarchical risk assessment, which utilizes reinforced prediction machine learning, nearly another 30% of cases can be pushed to 90% accuracy. In total, about 75% of cases can therefore have greater than 90% accuracy. That would leave something like 25% or less of all cases having to employ hierarchical levels of risk assessment that employ less than 90% accuracy. Given that merchant loss prediction is calculated as a function of the amount of exposure times the merchant risk rating (or risk exposure estimate 544), the ability to predict merchant loss for the facilitator and make business decisions accordingly is massively enhanced using the technical tools provided herein.

Thus, the travel risk rating module 500 can easily and seamlessly handle terabytes of data in short periods of time to determine whether, at a first level of hierarchy, huge accuracy increases can be achieved by monitoring signals not previously obtainable via the travel risk AI module 510 scraping data from web site information to obtain the scraped travel exposure data 527 therefrom and achieve accuracy of greater than 96% for the risk exposure estimate 544. Automatically, if the scraped travel exposure data 527 is not available, as a next level in the hierarchy of the travel risk determination methodology of the travel risk rating module 500, reinforced labeling (done a priori with similar data as learned by the travel risk monitoring machine learning module 512) with prediction machine learning may be employed to achieve greater than 90% accuracy. If this information is also not determinable, then the travel risk monitoring machine learning module 512 may automatically, and again without any human intervention, turn to industry or sub-industry ratings that include mappings of risk ratings to corresponding industry or sub-industry affiliations between the merchant under consideration and respective categories of industry/sub-industry, which covers about 20% of cases. By further employing reinforced machine learning to improve affiliation identification and learn from longer relationships and scoring efforts employed on specific industry/sub-industry categories, accuracy for this type of (third level) hierarchical risk exposure determination can also be improved to about 50% accuracy.

The reinforced machine learning of the travel risk monitoring machine learning module 512 may be accomplished through operator interaction via the review dashboard 550 to build up and train the travel risk monitoring machine learning module 512 offline. However, online training and learning may also be employed. Thus, for example, the travel risk monitoring machine learning module 512 may employ one or more instances of a neural network (e.g., a CNN), a support vector machine (SVM), Bayesian network, logistic regression, logistic classification, decision tree, ensemble classifier or other machine learning model to process inputs received by the travel risk monitoring machine learning module 512 to generate outputs as described herein. The travel risk monitoring machine learning module 512 may be supervised (identifying patterns in raw data upon which inference processes are desired to be performed via training examples) or unsupervised (identifying patterns in raw data upon which inference processes are desired to be performed without training examples). In an example embodiment, the travel risk monitoring machine learning module 512 may include a neural network of nodes where each node includes input values, a set of weights, and an activation function. The neural network node may calculate the activation function on the input values to produce an output value. The activation function may be a non-linear function computed on the weighted sum of the input values plus an optional constant. Neural network nodes may be connected to each other such that the output of one node is the input of another node. Moreover, neural network nodes may be organized into layers, each layer comprising one or more nodes. The neural network may be trained and update its internal parameters via backpropagation during training. A CNN may be a type of neural network that further adds one or more convolutional filters (e.g., kernels) that operate on the outputs of the preceding neural network layer to produce and output to then next layer. The convolutional filters may have a window in which they operate, which is spatially local. A node of a preceding layer may be connected to a node in the current layer if the node of the preceding layer is within the window. If not within the window, then the nodes are not connected. The CNN can therefore process massive amounts of information and detect patterns therein in relatively short periods of time as compared to general purpose computers, regardless of their programming and processor speeds.

Finally, as a fourth level in a hierarchy of risk exposure determination methods, the travel risk rating module 500 may apply a default value if no information about industry can be determined, which may account for about 5% of cases where, historically, default values for uncategorized merchants tend to render only about 10% accuracy of the merchant risk rating. However, by employing the travel risk rating module 500 a waterfall analytical process employing different hierarchical levels of analysis and accuracy can be employed to massively improve overall performance by taking a large segment of scenarios seamlessly into a high accuracy category by enabling new signals to be analyzed that previously were untouchable do to a lack of tools practically able to handle the processing load in the time required.

Within the context above, it may be appreciated that categorization of merchants may play a significant role in accurately determining a merchant risk rating for the merchant. Categorization often includes industry or sub-industry segmentation, and such categorization is certainly helpful. However, further categorization on the basis of characteristics other than industry may also be helpful in some cases. In this regard, for example, categorization of some merchants on the basis of seasonality may also be useful. Volume drop, which refers to significant reductions in loan volumes at a given period of time, can be a key pattern recognizable to improve credit risk monitoring. Thus, for example, the CNN or other machine learning components may be trained to identify volume drop. However, for merchants with businesses that are seasonal in nature, a certain amount of volume drop may be normal or entirely expected. Thus, identifying the volume drop may not be indicative of a problem, but instead reinforcing of what is already known or expected. Thus, categorizing merchants as seasonal, non-seasonal, or probably seasonal may allow analysis to consider the particular nature of the merchant and avoid false alarms. With seasonal adjustment or consideration, forecasting accuracy can distinguish normal seasonal fluctuations from unusual volume drop, and adjust risk monitoring ratings accordingly. Thus, for example, models employed for machine learning may be time series models that include seasonal decomposition to predict merchant loan volume trends. In this regard, seasonal impacts may be removed to accurately predict trends, and then seasonal fluctuations may be reintroduced to obtain final predicted results. Final predicted results may be compared to actual sales data to define volume drop when actual sales fall below lower predicted interval bounds.

In this context, the lower predicted interval bounds may be determined based in part on a predicted interval cutoff. The predicted interval cutoff may refer to a likelihood that future observations will fall within a specified range. The predicted interval may be determined as a predicted value at a given time summed with a product of a critical value from a standard normal distribution corresponding to a desired confidence level with a standard deviation of the predicted value. The larger the cutoff, the wider the area defined, thereby reducing the likelihood of a merchant being classified as experiencing volume drop. In some cases, a loss coverage heat map may be used to identify cutoffs. In this regard, the goal may be to optimize the cutoff selection to cover more losses while maintaining the significance of the volume drop pattern. FIG. 7 illustrates a heat map 700 in which the vertical axis provides merchant total loan volumes in the last 30 days and the horizontal axis provides a predicated interval lower bound. From this information, a selected volume drop cutoff curve may be achieved by keeping the most statistically significant data showing volume drop pattern and addressing 85% of credit losses.

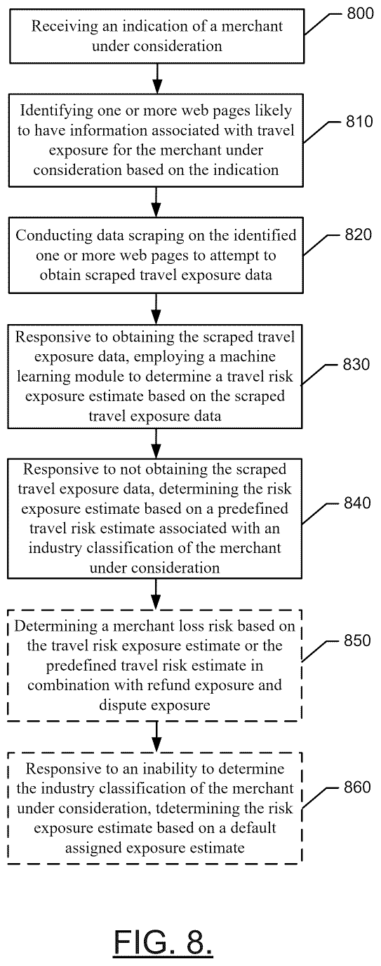

From a technical perspective, the SFP platform 10, and more particularly the facilitation agent 44, described above may be used to support some or all of the operations described above. As such, the apparatus described in FIG. 2 may be used to facilitate the implementation of several computer program and/or network communication based interactions. As an example, FIG. 8 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal (e.g., client 20, merchant client 60, application server 40, and/or the like) and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method for extracting and conditioning content for use in a hierarchically structured merchant risk monitoring environment is shown in FIG. 8. The method may include receiving an indication of a merchant under consideration at operation 800, identifying one or more web pages likely to have information associated with travel exposure for the merchant under consideration based on the indication at operation 810, and conducting data scraping on the identified one or more web pages to attempt to obtain scraped travel exposure data at operation 820. Responsive to obtaining the scraped travel exposure data, the method may further include employing a machine learning module to determine a travel risk exposure estimate based on the scraped travel exposure data at operation 830. Responsive to not obtaining the scraped travel exposure data, the method may further include determining the risk exposure estimate based on a predefined travel risk estimate associated with an industry classification of the merchant under consideration at operation 840. The method of FIG. 8 may be conducted for initial onboarding of a merchant such as when the merchant under consideration is being considered for onboarding, and therefore before substantial engagement with the merchant. However, the method of FIG. 8 may also be conducted after a merchant has already been onboarded as a periodic review of the overall health of the merchant and their continued operation on the platform. Thus, being under consideration in that context would simply imply consideration for continued operation and not for initial onboarding.

In an example embodiment, an apparatus for performing the method of FIG. 8 above may comprise a processor (e.g., the processor 102) or processing circuitry configured to perform some or each of the operations (800-840) described above. The processor may, for example, be configured to perform the operations (800-840) by performing hardware implemented logical functions, executing stored instructions, or executing algorithms for performing each of the operations. In some embodiments, the processor or processing circuitry may be further configured for additional operations or optional modifications to operations 800 to 840.

In some embodiments, the method (and a corresponding apparatus or system configured to perform the operations of the method) may include (or be configured to perform) additional components/modules, optional operations, and/or the components/operations described above may be modified or augmented. Some examples of modifications, optional operations and augmentations are described below. It should be appreciated that the modifications, optional operations and augmentations may each be added alone, or they may be added cumulatively in any desirable combination. In this regard, for example, The method may further include determining a merchant loss risk based on the travel risk exposure estimate or the predefined travel risk estimate in combination with refund exposure and dispute exposure at operation 850. In an example embodiment, responsive to an inability to determine the industry classification of the merchant under consideration, the method may further include determining the risk exposure estimate based on a default assigned exposure estimate at operation 860. In some cases, the indication may include information indicative of a website or web content associated with the merchant under consideration. In an example embodiment, the information associated with travel exposure may include one or more of itinerary data, shipping information and return policy information for the merchant under consideration. In some cases, conducting data scraping may include employing a large language model (LLM) stage to analyze the identified one or more web pages to extract the scraped travel exposure data. In an example embodiment, the LLM stage may include multiple LLMs and different ones of the multiple LLMs are associated with respective different forms of information conveyance. In some cases, the LLM stage outputs a confidence score for information extracted using each of the different forms of information conveyance, and the information extracted is only communicated as the scraped travel exposure data in response to the confidence score being higher than a threshold. In an example embodiment, the LLM stage may employ keyword-based scraping and fallback scraping. The keyword-based scraping may define target sub-domains including specifically targeted words defining a flag indicating a relationship to a travel exposure topic for an industry segment and defining a temporal limitation, and the fallback scraping may identify a predefined section of a website, and a scraping depth. In some cases, the LLM stage may include one or more LLMs that are tailored to a particular form of content via reinforced learning from human feedback (RLHF) configuring the one or more LLMs to process websites and webpages in various formats and locations.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A method of extracting and conditioning content for use in a hierarchically structured merchant risk monitoring environment, the method comprising:
receiving an indication of a merchant under consideration;
identifying one or more web pages likely to have information associated with travel exposure for the merchant under consideration based on the indication;
conducting data scraping on the identified one or more web pages to attempt to obtain scraped travel exposure data;
responsive to obtaining the scraped travel exposure data, employing a machine learning module to determine a travel risk exposure estimate based on the scraped travel exposure data; and
responsive to not obtaining the scraped travel exposure data, determining the risk exposure estimate based on a predefined travel risk estimate associated with an industry classification of the merchant under consideration.

2. The method of claim 1, further comprising determining a merchant loss risk based on the travel risk exposure estimate or the predefined travel risk estimate in combination with refund exposure and dispute exposure.

3. The method of claim 1, wherein, responsive to an inability to determine the industry classification of the merchant under consideration, the method further comprises determining the risk exposure estimate based on a default assigned exposure estimate.

4. The method of claim 1, wherein the indication comprises information indicative of a website or web content associated with the merchant under consideration.

5. The method of claim 1, wherein the information associated with travel exposure includes one or more of itinerary data, shipping information and return policy information for the merchant under consideration.

6. The method of claim 5, wherein conducting data scraping comprises employing a large language model (LLM) stage to analyze the identified one or more web pages to extract the scraped travel exposure data.

7. The method of claim 6, wherein the LLM stage includes multiple LLMs and different ones of the multiple LLMs are associated with respective different forms of information conveyance.

8. The method of claim 7, wherein the LLM stage outputs a confidence score for information extracted using each of the different forms of information conveyance, and
wherein the information extracted is only communicated as the scraped travel exposure data in response to the confidence score being higher than a threshold.

9. The method of claim 6, wherein the LLM stage employs keyword-based scraping and fallback scraping,
wherein the keyword-based scraping defines target sub-domains including specifically targeted words defining a flag indicating a relationship to a travel exposure topic for an industry segment and defining a temporal limitation, and
wherein the fallback scraping identifies a predefined section of a website, and a scraping depth.

10. The method of claim 1, wherein the LLM stage comprises one or more LLMs that are tailored to a particular form of content via reinforced learning from human feedback (RLHF) configuring the one or more LLMs to process websites and webpages in various formats and locations.

11. An apparatus for extracting and conditioning content for use in a hierarchically structured merchant risk monitoring environment, the apparatus comprising processing circuitry for:
receiving an indication of a merchant under consideration;
identifying one or more web pages likely to have information associated with travel exposure for the merchant under consideration based on the indication;
conducting data scraping on the identified one or more web pages to attempt to obtain scraped travel exposure data;
responsive to obtaining the scraped travel exposure data, employing a machine learning module to determine a travel risk exposure estimate based on the scraped travel exposure data; and
responsive to not obtaining the scraped travel exposure data, determining the risk exposure estimate based on a predefined travel risk estimate associated with an industry classification of the merchant under consideration.

12. The apparatus of claim 11, wherein the processing circuitry is further configured for determining a merchant loss risk based on the travel risk exposure estimate or the predefined travel risk estimate in combination with refund exposure and dispute exposure.

13. The apparatus of claim 11, wherein, responsive to an inability to determine the industry classification of the merchant under consideration, the processing circuitry is further configured for determining the risk exposure estimate based on a default assigned exposure estimate.

14. The apparatus of claim 11, wherein the indication comprises information indicative of a website or web content associated with the merchant under consideration.

15. The apparatus of claim 11, wherein the information associated with travel exposure includes one or more of itinerary data, shipping information and return policy information for the merchant under consideration.

16. The apparatus of claim 15, wherein conducting data scraping comprises employing a large language model (LLM) stage to analyze the identified one or more web pages to extract the scraped travel exposure data.

17. The apparatus of claim 16, wherein the LLM stage includes multiple LLMs and different ones of the multiple LLMs are associated with respective different forms of information conveyance.

18. The apparatus of claim 17, wherein the LLM stage outputs a confidence score for information extracted using each of the different forms of information conveyance, and
wherein the information extracted is only communicated as the scraped travel exposure data in response to the confidence score being higher than a threshold.

19. The apparatus of claim 16, wherein the LLM stage employs keyword-based scraping and fallback scraping,
wherein the keyword-based scraping defines target sub-domains including specifically targeted words defining a flag indicating a relationship to a travel exposure topic for an industry segment and defining a temporal limitation, and
wherein the fallback scraping identifies a predefined section of a website, and a scraping depth.

20. The apparatus of claim 11, wherein the LLM stage comprises one or more LLMs that are tailored to a particular form of content via reinforced learning from human feedback (RLHF) configuring the one or more LLMs to process websites and webpages in various formats and locations.
